(19) United States
(12) Patent Application Publication
(10) Pub. No.: US 2011/0285507 A1
(43) Pub. Date: Nov. 24, 2011

(54) Tamper Detection RFID Tape

(76) Inventor: Erik T. Nelson, Annandale, VA (US)

(21) Appl. No.: 12/784,832

(22) Filed: May 21, 2010

(51) Int. Cl. H04Q 5/22

(52) U.S. Cl. 340/10.1

(57) ABSTRACT

A wrapping material includes a sheet of non-rigid material; a first substantially planar RFID that is attached to the sheet of non-rigid material, the first RFID having a main body and a closed-loop conductor extending from the main body of the first RFID; and a second substantially planar RFID is attached to the sheet, the second RFID having a main body and a closed-loop conductor extending from the main body of the second RFID; and wherein the closed-loop conductor of the first RFID is arranged relative to the closed-loop conductor of the second RFID such that all straight lines that lie between the first RFID and the second RFID and that do not intersect the main body of the first RFID or the second RFID intersect the closed-loop conductor of the first RFID and/or the second RFID.

### BRIEF DESCRIPTION OF THE SEVERAL VIEWS OF THE DRAWINGS

FIG. 1 illustrates a system for using RFID tags to detect whether a box has been opened after it has been received from transit.

FIG. 2A is a flow chart that illustrates some of the operations that the shipper's RFID scanner may perform before the container is shipped.

FIG. 2B is a flow chart that illustrates some of the operations that the recipient's scanner may perform after the container has been received.

FIG. 3 illustrates a strip of tape having a single RFID tag on the strip.

FIG. 4 illustrates a strip of tape that is divided into patches that each have one RFID tag.

FIG. 5 illustrates a strip of tape that is divided into patches that each have two RFID tags.

FIG. 6 illustrates a strip of tape that is divided into patches that each have three RFID tags.

FIG. 7 illustrates a strip of tape that is divided into overlapping patches.

FIG. 8 illustrates a strip of tape that has multiple RFID tags on the strip.

FIG. 9 illustrates a wrapping material with RFID tags that span the length and width of the material.

FIG. 10 illustrates a RFID tag configuration where some tag components may more likely be peeled off with a piece of tape than other tag components.

FIG. 11 illustrates another RFID tag configuration where some tag components may more likely be peeled off with a piece of tape than other tag components.

FIG. 12 illustrates yet another RFID tag configuration where some tag components may more likely be peeled off within a piece of tape than other tag components.

FIG. 13 illustrates yet another RFID tag configuration where some tag components may more likely be peeled off within a piece of tape than other tag components.

FIG. 14 illustrates a passive RFID tag.

FIG. 15 illustrates an active RFID tag.

### DETAILED DESCRIPTION OF EMBODIMENTS

The embodiments described below illustrate the use of RFID tags to detect whether a container, such as a box, case, chest, carton, crate, bottle, or jar has been opened, or when wrapping material surrounding such containers have been removed. In general, a RFID tag may be placed on the container in a location and manner such that opening the container would also disable the RFID tag. Detecting whether the RFID tag has been disabled may yield an approximate indication of whether the container has been opened. A RFID tag may also be placed on or within a wrapping material, such as stretch wrap or shrink wrap, which may substantially enclose one or more containers. In the latter scenario, detecting whether the RFID tag has been disabled may yield an approximate indication of whether the wrapping material has been removed.

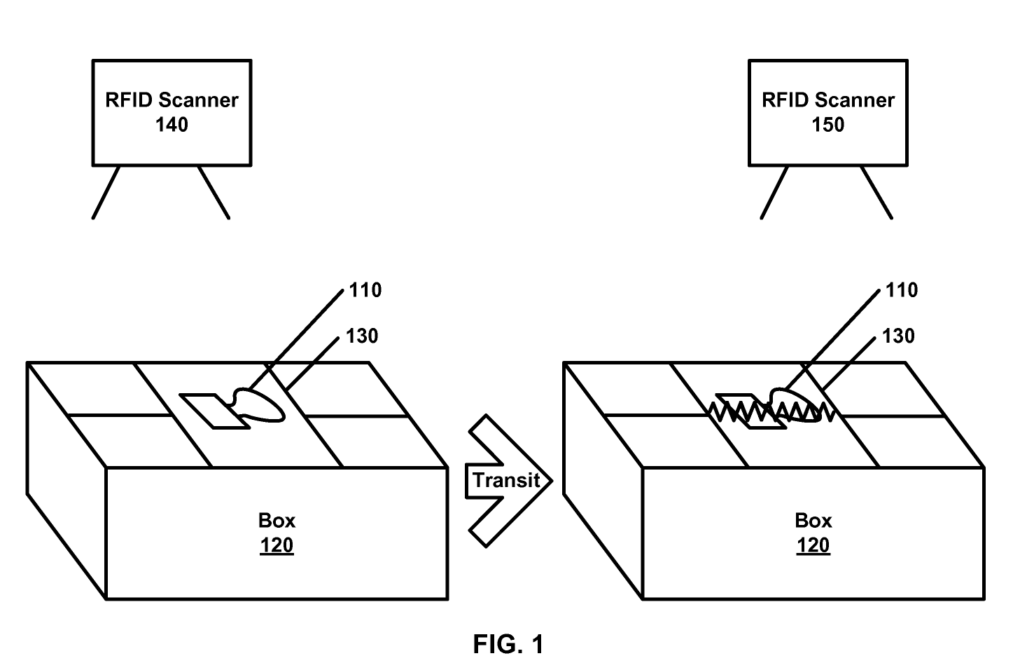

FIG. 1 illustrates one manner in which a RFID tag 110 or tags may be used to detect whether a box 120 has been opened. In this illustration, the box 120 may be closed by folding down the two flaps on the top of the box and keeping the two flaps in that position. A piece of tape 130 may be applied across the two flaps. The tape 130 may be used to keep the two flaps in the closed position, or the flaps may already be maintained in such a position. The piece of tape 130 has one or more RFID tags 110 affixed to it. The RFID tag 110 or tags may be affixed to the tape 130 by adhering it to either side of the tape, or by embedding it in the tape 130. Although this illustration shows a single strip of tape 130 across the two flaps on the top of the box 120, other arrangements for applying the tape 130 exist. For example, the strip of tape 130 may be long enough to extend from the top of the box 120 to other sides of the box 120. It may wrap around the box 120, running across four of its sides, once or multiple times. Although tape is used in this embodiment, materials without coated adhesives may be used. They comprise polypropylene, polyester, nylon, or even paper. If the material is arranged as a strip, the ends of the strip may be joined through adhesives, seals, joints, heating, welding, or other mechanical or chemical methods.

In another example, a piece of tape may completely or substantially wrap the entire surface of a box. This may be accomplished by wrapping a long strip of tape around the box in a spiral pattern. Alternatively, rather than configuring the tape as a strip, it may have dimensions that are commensurate with or greater than some of the dimensions of the box. In that case, the tape may be used to substantially cover the surface of the box. Although tape is used as one example of a sheet of wrapping material, a sheet of other wrapping materials may be used. In general, a sheet refers to a two-dimensional material and includes pieces of tape, plastic wrap, paper wrap, or a wrap made of some other wrapping material. The wrapping material does not need to be coated with an adhesive. For example, the wrapping material may be stretch wrap that is used to bundle one or more containers to a pallet, or shrink wrap that bundles a box with some attached document. In the former example, if the stretch wrap encloses the pallet and its containers, then the stretch wrap is surrounding the containers even if it does not directly touch the entire surface area of the containers. The object being wrapped does not need to be a container. For example, shrink wrap could be used to wrap objects on a pallet. In another example, shrink wrap could be used to wrap an object such as a book. The wrapping material may comprise a variety of substances, including polyester, polyolefin, PVC, other plastics, polymers, textiles, canvas, or even paper. For a non-adhesive sheet, adhesives may be applied at the edge of the sheet. When the sheet is folded over or around the object being wrapped, the adhesive on one edge may adhere that edge to another part of the sheet. This keeps the sheet in a wrapped configuration around the object. In another embodiment, tape may be used to tape together the edges of the plastic sheet so that the sheet forms an enclosure around the box, or to tape the edges of the plastic sheet to the surface of the object. An adhesive includes liquid materials such as glue or epoxy, but may also include solid materials like Velcro®. In another example, mechanical methods such as staples, zippers, nails, pins, or screws may be used to secure the plastic sheet to the box, or to form the plastic sheet into an enclosure around the box. As described later, RFID tags may be affixed to the wrapping material and arranged in a way such that making an opening in the material will likely disable at least one of the RFID tags. A RFID tag or tags may be attached to a container by affixing the tags to either side of the wrapping material or embedding it within the material. A RFID tag or tags may be considered to be attached to a box, for example, even if it does not directly touch the box. Because opening the box usually requires removing the wrapping material, detecting whether one of the RFID tags affixed to the material have been disabled may give an indirect indication of whether the box has been opened.

If the wrapping material is not completely removed, a hole or some other perforation may still be made in the box. In this case, even if the lid or flap of the box is still in a closed position and wrapping material covers that portion, the box may still be considered as opened. In general, a box or any other container may be considered opened when its contents are exposed. Therefore, opening a box comprises cutting a hole in the cardboard box to expose its contents. A strip of tape may determine when a container has been opened at a specific locus or loci, such as where a container lid meets the container body. A wrapping material may more easily determine when a container has been opened in an arbitrary location, such as when a perforation is made on the side of a box.

As stated above, the wrapping material may be applied to more than just containers. Objects like appliances, books, or consumer electronics may be directly wrapped in the wrapping material. If the contents were laptops, strips of tape or bigger sheets of wrapping material, with dimensions commensurate with that of the laptop, may be used to wrap the laptop. Detecting whether one or more RFID tags on or embedded in the material has been disabled may give an approximate indication of whether the wrapping material has been removed. Removal of the wrapping material may indicate, for example, that the appliance or consumer electronic in the wrapping has been shelved, placed in operation, activated, or put on display.

Referring again to FIG. 1, after a RFID tag 110 or tags are attached to a box by affixing them to a piece of tape or some other wrapping material, an optional RFID scanner 140 may obtain the tag's 110 or tags' identification information. The RFID scanner 140 may be a RFID interrogator or any other device capable of receiving and relaying a wireless signal. The identification information that the scanner 140 obtains from a RFID tag 110 may be a single bit, which may simply indicate the presence or the operational status (i.e. not disabled) of the tag 110. The identification information may also comprise a plurality of bits, which may form a serial number that uniquely identifies the RFID tag 110. The bits may be transmitted to the scanner 140 sequentially or simultaneously. Simultaneous transmission may be accomplished by, for example, allocating a sufficiently wide band or bands of spectrum to modulate the bits simultaneously for transmission. The tags and the scanner 140 may be configured to operate in a variety of frequency ranges, including the KHz, MHz, GHz, or THz ranges. The obtained identification information may optionally be stored in a database (not shown), which may associate the RFID tag's 110 identification information with the box 120. The association may be manually entered, such as in a table whose entries are manually set, or may be automatically made in some other database data structure. The database may associate a specific container with any set of RFID tags attached to it. After the optional scanning, the box 120 may then be placed in transit.

After the box 120 has been received, it may be opened by breaking or peeling the tape 130 on the box 120. Breaking or peeling the tape 130 should disable the RFID tag 110 or tags affixed to the tape 130. A disabled RFID tag 110 is likely unable to transmit its identification information to the receiving party's RFID scanner 150. The RFID scanner 150 may monitor for self-initiated transmissions of identification information or for responses to requests for identification information. The absence of such a self-initiated or response transmission may therefore indicate that the tape 130 has been broken and the box 120 has been opened. If the box 120 surface were substantially enclosed with a wrapping material, the absence of a self-initiated transmission or response transmission may indicate that an opening has been made in the wrapping material to remove the material and open the box 120.

If a single RFID tag is affixed to a piece of tape, the absence of a transmission of identification information from that tag is an approximate indication that the box has been opened. However, the absence of a transmission of identification information also arises when the box has not yet been received from transit. To indicate that the box has been both received and opened, two RFID tags may be affixed to the tape such that opening the box disables one of the RFID tags, but not the other. For example, the two RFID tags may be placed sufficiently far apart so that an action which disables one RFID tag does not affect the other RFID tag. If there is an absence of identification information from both RFID tags, then the box to which the RFID tags were attached has likely not yet been received or has been removed outside the receiving range of the recipient's RFID scanner. If identification information has been received from both RFID tags, then the box has been received and has likely not been opened. If identification information has been received from only one of the RFID tags, then the box has been received and has likely been opened. The formula may be summarized as:

TABLE 1

| Transmission | Transmission | |
|---|---|---|
| from Tag 1 | from Tag 2 | Package Tracking indication |
| No | No | Package Not Received/Package Removed |
| No | Yes | Package Received and Opened |
| Yes | No | Package Received and Opened |
| Yes | Yes | Package Received and Unopened |

More RFID tags may be attached to a container. For example, if the container has multiple locations where it may be opened, a piece of tape having at least one RFID tag may need to be placed at each of those locations. For example, a typical cardboard box may be opened at the top or at the bottom of the box. A certain type of container may be assigned a fixed number of RFID tags that are to be attached to it. To detect whether a container remains closed, a recipient of the container may monitor for self-initiated transmissions of or responses to requests for identification information. The number of self-initiated transmissions or responses may indicate the number of transmitting RFID tags. If the number of transmitting RFID tags on the received container equals the assigned number of RFID tags for that type of container, then the container likely has not been opened. If the number of transmitting RFID tags is less than the assigned number, then the container likely has been opened. For example, a shipper may always attach four RFID tags to a certain type of crate. The recipient of the crate may determine whether it has received identification information from four RFID tags. If no RFID tag has transmitted its identification information, then the crate may not yet have been received. If four RFID tags have transmitted their identification information, then the crate associated with the tags has been received and remains unopened. If one to three RFID tags have transmitted their identification information, then the crate has been received and has likely been opened.

Alternatively, each type of container may have a variable number of attached RFID tags. A shipper's RFID scanner may monitor either self-initiated transmissions of identification information or send requests for such information. Based on the number of transmissions received by the scanner, the number of RFID tags attached to the shipped container may be determined and recorded. The shipper may communicate this number to the intended recipient of the container, or make the number available for the recipient to query. After the container has been received, the recipient's scanner may determine the number of attached RFID tags that are still operational enough to transmit their identification information. The recipient may then compare the number of operational RFID tags with the number provided by the shipper of how many RFID tags were originally attached. If the number of operational RFID tags on the received container is less than the number of tags originally attached by the shipper, the received container has likely been opened.

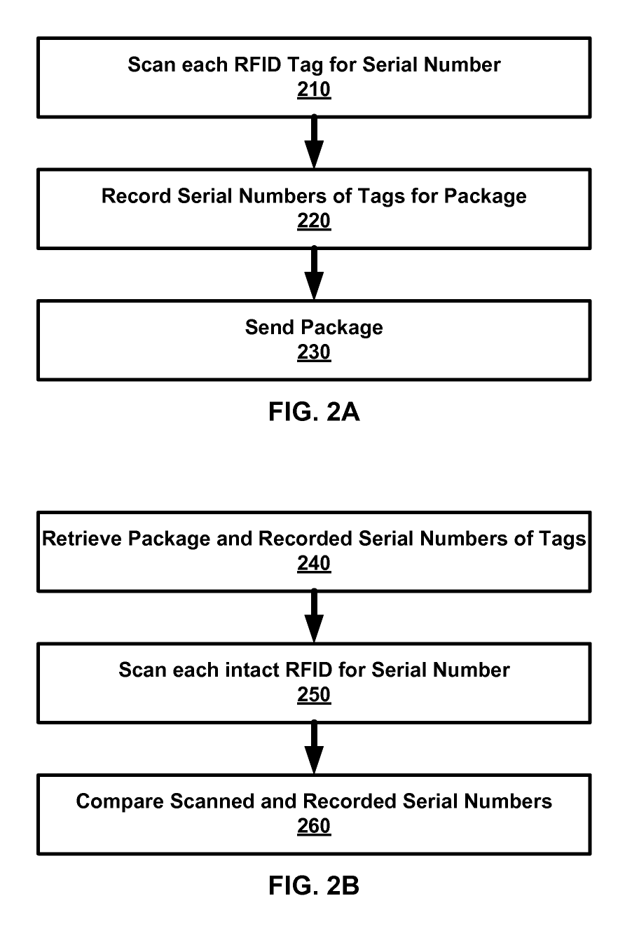

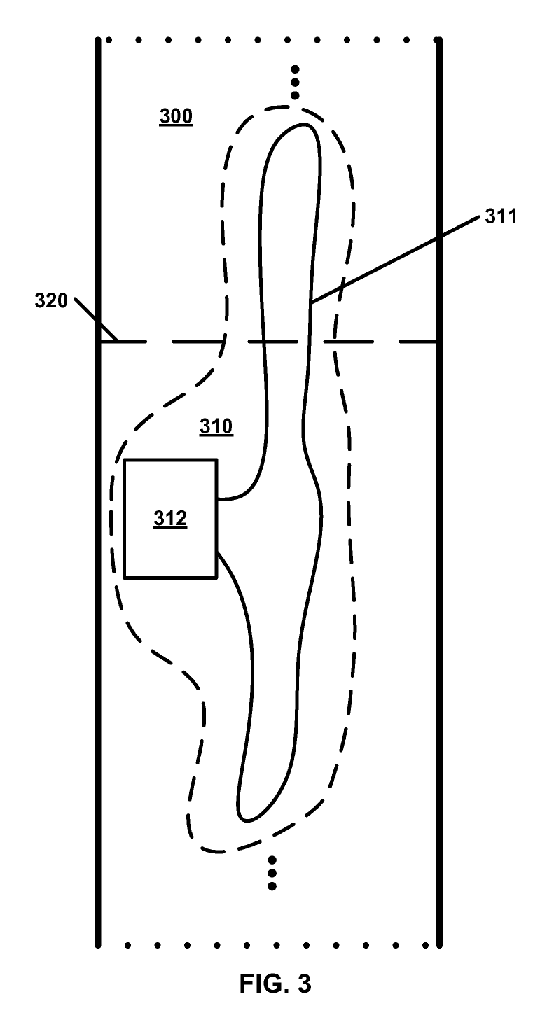

FIG. 2A and FIG. 2B illustrate one flow diagram that performs this comparison. In the illustration, the identification information for each RFID tag comprises a serial number. In 210, the shipper's RFID scanner scans each RFID tag attached to a container for the tag's serial number. If the RFID tag is a passive device, the scanner may send a request for identification information to the tag. The scanner's request signal will provide the energy to access the storage of the RFID tag and to transmit the stored identification information back to the RFID scanner or to a separate RFID receiver. If the RFID tag is a battery-assisted passive (BAP) device, the scanner may send a request, which will provide the energy to wake up the RFID tag. The tag will then use its own power supply to transmit its serial number back to the RFID scanner. Alternatively, if the RFID tag is an active tag, the RFID scanner may send no request, and instead monitor for self-initiated transmissions of identification information from the tag.

In 220, the scanned serial numbers that identify the RFID tags may be recorded so that they may be later compared with the RFID serial numbers obtained by a recipient of the same container. The recording may be performed in a database. Each serial number recorded in the database represents one RFID tag affixed to a tape or other wrapping material on the container. The serial number may be directly associated with the container or may be directly associated with the serial number of another RFID tag on the container. After the serial numbers are recorded, the container may be placed in transit in 230.

FIG. 2B shows that, after the container has been received, the recipient in 240 may access the database to retrieve the serial numbers of the RFID tags that had been attached to the container before it was shipped. The quantity of serial numbers recorded in the database will reflect the number of RFID tags that had been attached to the container. To the recipient, the serial numbers in the database may be considered as prerecorded by the shipper. Therefore, a recipient who accesses the database to determine the quantity of serial numbers recorded in the database may be considered to be accessing a prerecorded quantity.

After the recipient determines the serial numbers of the RFID tags that had been attached to the container before it was shipped, the recipient may determine the serial numbers of the RFID tags that are attached to the container and are still operational. In 250, the recipient's scanner may scan the RFID tags for their serial numbers. As in 210, the scanner may send requests for serial numbers to the RFID tags or may receive self-initiated transmissions of serial numbers from the tags. If a RFID tag is disabled when the container is opened, then the scanner will likely not receive a serial number from that tag. In 260, the serial numbers received by the recipient's scanner may be compared with the serial numbers recorded in the database before shipment. In one mode of comparison, the quantity of serial numbers received by the recipient's scanner is compared with the quantity of serial numbers recorded in the database. That is, the quantity of transmitted serial numbers received is compared with the prerecorded quantity from the database. If fewer serial numbers have been received by the recipient's scanner than were recorded in the database, then one or more RFID tags has likely been disabled and the container has likely been opened.

In another mode of comparison, the values of the serial numbers may be compared. For example, if tampering of a container occurs, the tampering party may attempt to hide the opening of the container by applying a new piece of tape or wrapping material having an affixed RFID tag. In that case, the quantity of RFID serial numbers received by the recipient's scanner may still equal the quantity of serial numbers stored in the database. However, if the serial numbers among a set of RFID tags are unique, the serial number of the RFID tag disabled by the tampering party will not have the same value as the serial number of the new RFID tag attached by the tampering party. If tampering has occurred, the recipient's scanner will receive the serial number of the new RFID tag, whereas the database holds the serial number of the disabled RFID tag. Comparing the values of the serial numbers may reveal that a different RFID tag has replaced one of the original RFID tags attached to the container. Such a substitution is consistent with the possibility of tampering.

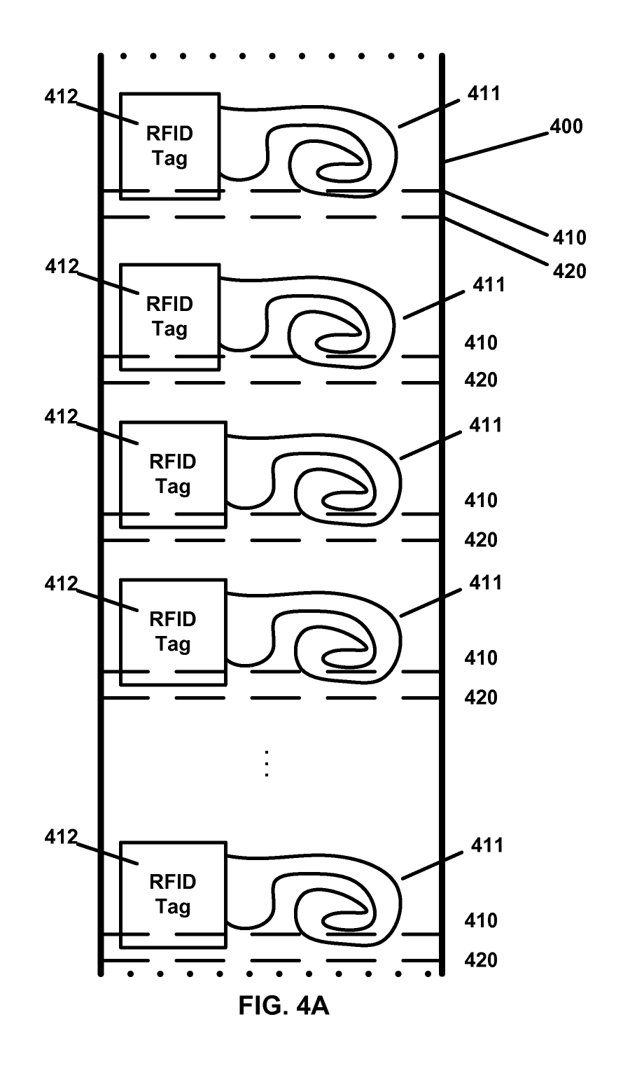

Numerous arrangements exist for arranging RFID tags on a container in a manner that causes the tag to be disabled when the container is opened. FIG. 3 shows one arrangement of a single RFID tag 310 on a strip of tape 300. The figure shows that a RFID tag 310 may comprise a main body 312 and a conductor 311 that must be intact for the RFID tag 310 to operate.

The conductor 311 may be the RFID antenna, or may be any other conductor that extends from the main body 312 of the RFID tag 310. For example, the conductor 311 may be a conducting wire that carries signals or power and extends from the main body 312. The conductor may form a closed loop by having a path that originates from the main body 312, extending beyond it, and returning back into the main body 312. This path may carry DC power or AC signals to portions of the RFID circuitry. Severing this path may cut off the power or signals needed by the RFID tag 310 to operate. As another example, the conductor 311 may provide a conductive path from the antenna to another portion of the RFID circuitry, such as a memory or signal processing unit. The antenna may be part of the main body 312 of the tag 310, or may also extend beyond the main body 312. In either placement, the conductor 311 may be considered to extend from the main body 312 even if part of the conductor 311 connects to a component outside of the main body 312, such as the antenna. So long as part of the conductor 311 goes into or comes from the main body 312, the conductor 311 may qualify to be considered as extending from the main body 312.

The conductor 311 may form a path that carries signals or power from the antenna to the rest of the RFID tag 310. Alternatively, the conductor 311 may function as an impedance-matching short-circuited stub. In the impedance-matching context, the conductor 311 may also be configured as an open-circuit (i.e. open loop) stub. Severing the conductor 311 in this context may impair the power transfer from the antenna to the rest of the RFID tag 310 or vice versa. The RFID tag 310 may be considered disabled if such an impairment causes a measurable attenuation in signals transmitted by the RFID tag 310.

Alternatively, the conductor 311 may constitute the RFID antenna. As part of the antenna, the conductor 311 may be an electrically closed-loop or open-loop structure. An open-loop structure, such as a dipole configuration, may be used. Severing an open-loop conductor may not completely disable the ability of the RFID tag 310 to transmit wireless signals, but may impair the dimensions needed for the conductor to optimally transmit. Such an impairment may cause a measurable attenuation in the signal transmitted by the RFID tag 310. In that case, a RFID tag 310 with an open-loop conductor may be considered disabled if the dimensions of the conductor have been diminished sufficiently to cause a measurable decrease in the strength of the signal transmitted by the RFID tag. Other configurations for the conductor 311, such as a folded dipole or J-pole, may be used. Although these examples illustrate the disabling of the RFID tag by severing the conductor 311, the RFID tag may also be disabled by severing parts of the main body 312.

The tape 300 may be placed over the opening of a container, such as across the two flaps on the top of a cardboard box. To open the box, the tape 300 must be cut or torn. FIG. 3 shows one line 320 of perforations that allows a person to tear the tape 300. The line 320 is optional, as a person may tear or cut the tape without the line. Tearing of the tape 300 may also be done without applying force directly to the tape. For example, if a piece of tape 300 is placed over the intersection of a bottle cap with the main body of the bottle, twisting the cap may tear apart the tape 300.

The arrangement in FIG. 3 shows that the RFID tag 310 may be disabled by severing the conductor 311. The RFID tag 310 may also be disabled by tearing or cutting across the main body 312 of the tag 310. For example, the tear line 320 may be moved to intersect the main body 312. Alternatively, the tape 300 itself may be placed such that it is likely to be cut or torn at a location that intersects the main body 312. For the box 120 in FIG. 1, for example, a likely location for cutting or tearing the tape 300 is along the intersection of the two flaps on the top of the box 120. Therefore, the tape may be placed at a location such that the main body 312 of the RFID tag affixed to the tape lies over the intersection of the two flaps. Although FIG. 3 shows a single RFID tag 310 on the strip of tape 300, other embodiments may contain more RFID tags. By increasing the length of the conductor 311, fewer RFID tags may be needed to cover the same length of tape. For a closed-loop conductor, lengthening a conductor refers to stretching the shape of the loop along a line that runs parallel to the length of the tape. If the conductor constituted the tag antenna, the overall size of the conductor may be limited by signal attenuations caused by size increases.

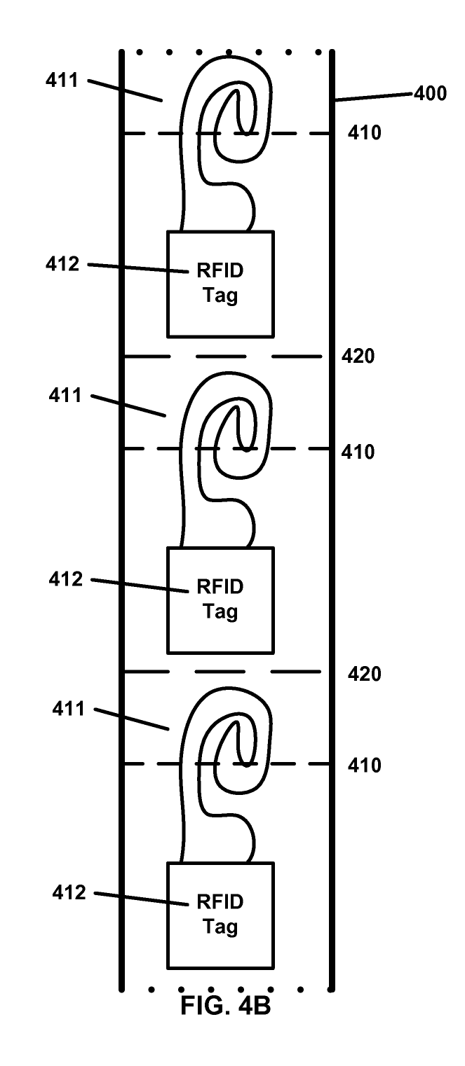

In contrast to the continuous strip of tape in FIG. 3 that may be cut to arbitrary lengths, FIG. 4A shows RFID tags on patches of tape 400 with a predefined length. Each patch may be applied to one of the openings of a container. For example, a patch may be applied across the two flaps on the top of a box or over an area that covers both the lid and the main body of a container. The patches may be precut, and may be dispensed by peeling a patch from a roll of underlying material, such as glassine, glossy paper, or plastic. Alternatively, the patches may be connected, and may be dispensed by tearing at the detach lines 420. In one embodiment, the patches may be two feet in width. However, the patches may be made to other widths, based on the size of the container and the RFID tags. The detach lines 420 are optional, as a user may tear or cut the tape 400 into patches without those lines. The tear line 410, which may be used to tear each individual patch when opening a container, is also optional. Although FIG. 4A shows a tear line 420 across both the conductor 411 and the main body 412 of the RFID tags, the conductor 411 may be narrowed or widened so that the tear line 410 intersects only the conductor 411 or only the main body 412. If the conductor 411 is widened, it may extend past the main body 412 of the RFID tag. The tear line 410 may then be positioned to intersect only the conductor 411 and not the main body 412. If the conductor 411 is narrowed, the main body 412 will extend past the conductor 411. The tear line 410 may then be positioned to intersect only the main body 412 and not the conductor 411. Although FIG. 4A shows a patch having a width and length commensurate with the RFID tag on the patch, the patch may also be substantially wider or longer than the RFID tag. Another set of dimensions for the patches is shown in FIG. 4B. Whereas the RFID tags in FIG. 4A are placed side to side, the tags in FIG. 4B may be placed end to end, with a conductor 411 that extends from the main body 412 of a tag and that runs along the length of the tape 400. This arrangement may reduce the width of the strip of tape 400. Because the tape 400 is likely to be torn across its width, reducing the width may allow a user to tear the tape more quickly or with less effort. Although these illustrations show that arranging RFID tags end to end may reduce the width of the tape, in other embodiments the width may be reduced by arranging the tags side to side.

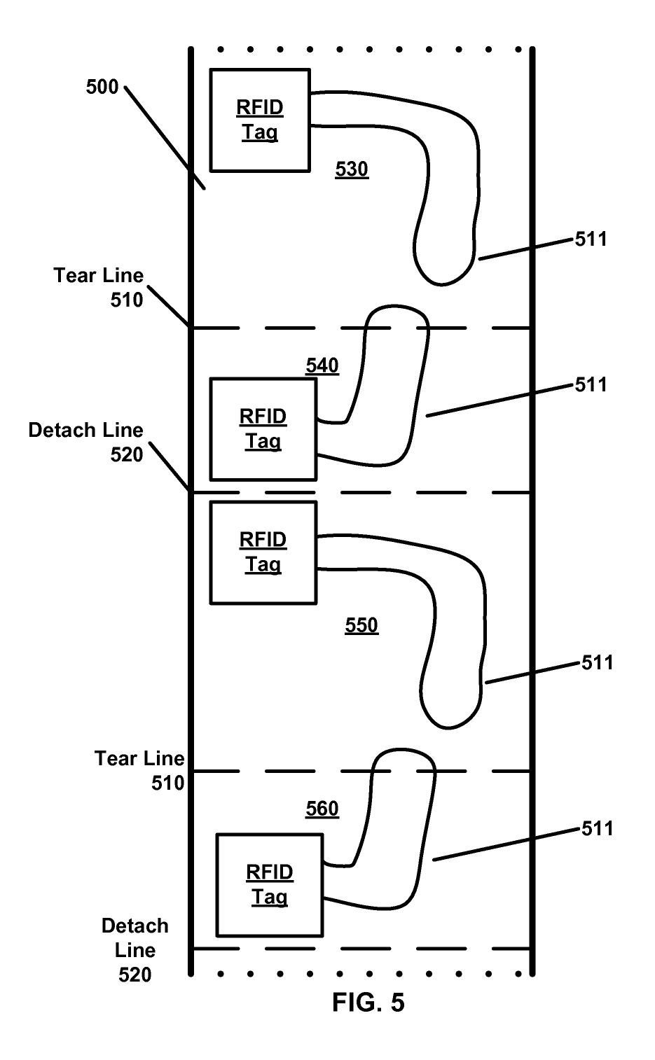

A patch may have more than one RFID tag. As discussed earlier, the use of two RFID tags allows for a distinction between a state where the container has been received and opened versus a state where the container has not yet been received. One way to attach two RFID tags to a container is to apply two of the patches shown in FIG. 4, with one of the patches attached to a location that is not likely to be cut or torn. Alternatively, FIG. 5 shows patches of tape 500 that each has two RFID tags. An optional tear line 510 runs across one RFID tag, but not the other. This tear line 510 may be placed over the opening of a container. The opening may be where two flaps on the top of a box meet, where a lid meets the main body of a container, or where a bottle cap meets the main body of the bottle. When the patch of tape is torn or cut to open the container, one (e.g. 540) of the two RFID tag will be disabled, while the other (e.g. 530) remains operational. The latter RFID tag 530 may continue to transmit its identification information so as to indicate that the container associated with the tag 530 has been both received and opened. FIG. 5 also shows a gap between the conductors 511 of tags 530 and 540. This gap ensures that a tear or a cut does not go across the conductors 511 of both RFID tags and therefore does not disable both tags.

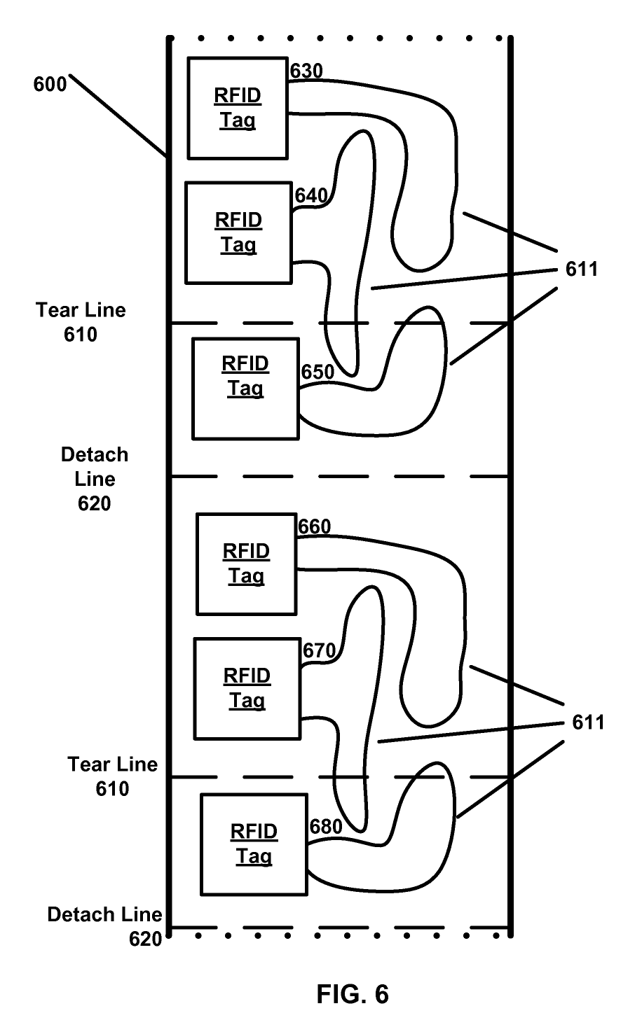

However, the gap also creates the possibility that the tape could be cut or torn across the gap, so that both RFID tags remain operational. In that case, both RFID tags may be able to transmit their identification information, creating an erroneous indication that the container has not been opened. FIG. 6 shows an arrangement that eliminates the gaps between the RFID tags. The figure shows at least two patches of tape 600, where each patch has three RFID tags that have conductors 611 that project over one another. In the context of this figure, two RFID tags have conductors 611 that project over one another if all straight lines that are parallel to the width of the tape and are between the two tags intersect at least one of the conductors 611. Such straight lines exclude lines that run substantially parallel to the length of the tape. That is, such straight lines exclude those lines that run between two RFID tags and intersect the main bodies of both tags, such as the main bodies 412 of FIG. 4A.

The projection leaves minimum (or no) gap from the conductor 611 of one RFID tag 630 to the conductor 611 of the adjacent RFID tag 640, or from that adjacent tag 640 to the next tag 650. When the patch on which the three tags are placed is cut or torn, at least one of the RFID tags 630, 640, and 650 is likely to be disabled. When the recipient of a container scans it for identification information, the receipt of identification information from only one or only two of the RFID tags indicates that the container has been received and opened. The receipt of identification information from all three RFID tags may indicate that the container has been received and has not been opened. The receipt of identification information from no RFID tag will continue to indicate that the container has not been received or is not within the range of the recipient's RFID scanner.

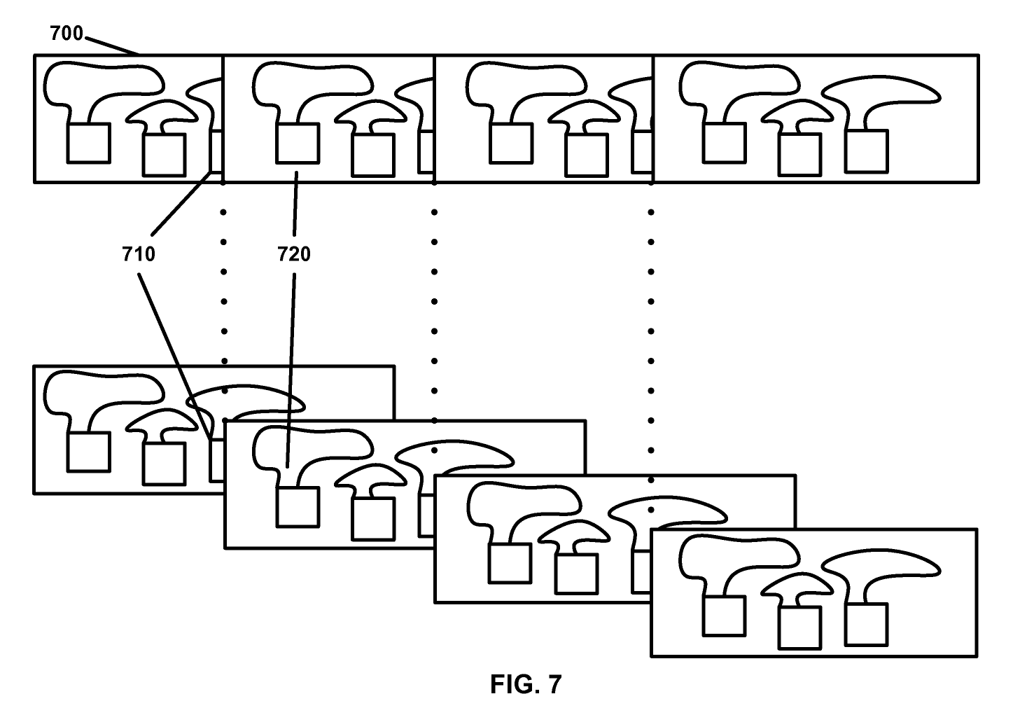

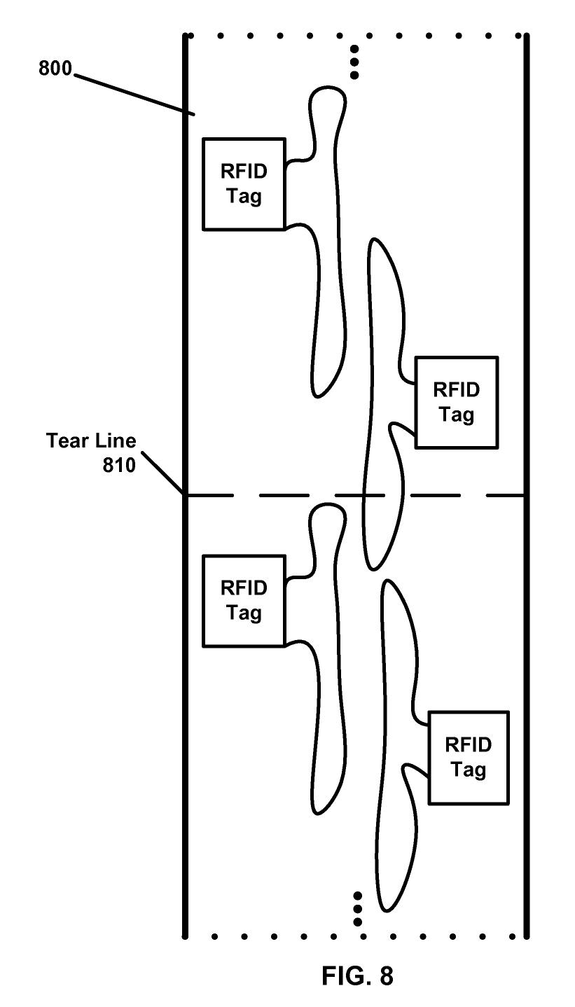

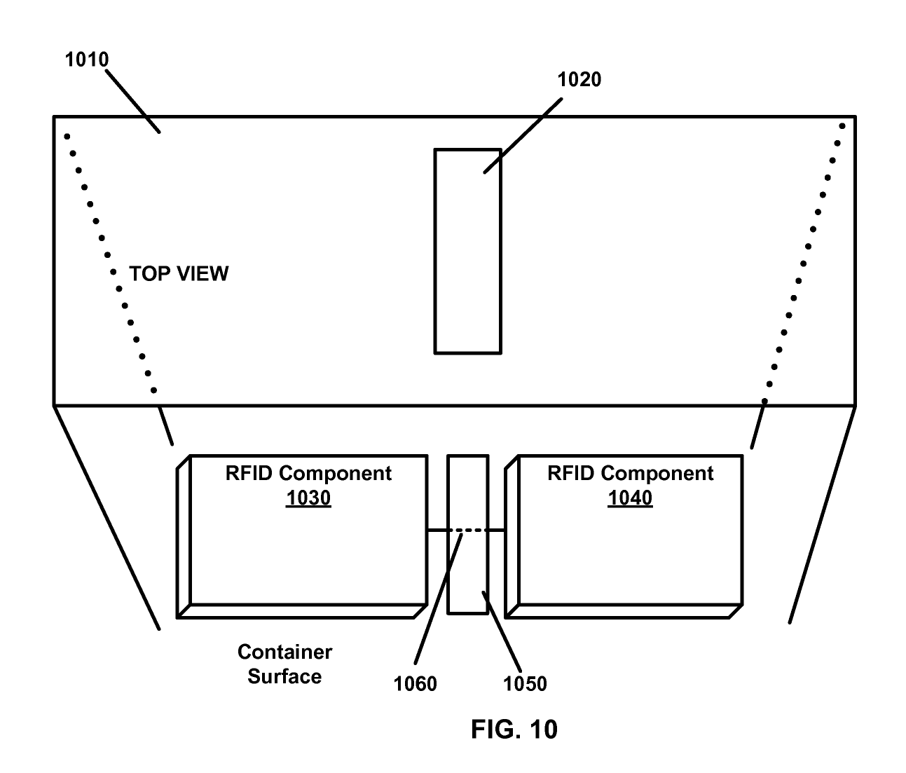

If the tape is intended to be wrapped around a container, such as around four sides of a box, using a continuous roll of tape may be more convenient than using individual patches of tape. Even though adjacent RFID tags on the same patch may have no gaps, tags on adjacent patches may be separated by a gap. For example, there is a gap between the bottom RFID tag 650 on one patch and the top RFID tag 660 on another patch. If both of the patches of FIG. 6 are applied to a container, the tape may be cut or torn across the gap so that no RFID tags are disabled. The container may then be opened by perforating the container in the vicinity of the gap or by peeling the severed tape 600. The opening would not be detected because the tearing or cutting occurs at a gap between the RFID tags of two different patches. FIG. 7 shows one configuration that eliminates the gaps between the RFID tags of adjacent patches. As the bottom of FIG. 7 shows, the patches on this strip of tape are arranged in layers, with one layer adhering to another. When multiple patches are used to make a single strip of tape 700, the RFID tags on adjacent patches may overlap. For example, RFID tag 710 lies on a layer below that of RFID tag 720. Although tags 710 and 720 may be electrically insulated from each other, the two tags may overlap in coverage. Cutting or tearing along any of the four patches of FIG. 7 may disable at least one RFID tag. As discussed in more detail in FIGS. 10-13 below, the components of the RFID tags may be configured so that peeling the tape disables the tags. In the context of FIG. 7, the tags may be configured so that peeling any of the patches from a container surface or from another patch disables the RFID tag on the part of the patch being peeled. The patches of tape may be dispensed as a roll of tape. Alternatively, so long as peeling a patch does not disable the tags on the patch, the patches of tape may also be stacked into layers, like a stack of Post-It® notes.

Whereas FIG. 7 shows several patches of tape adhered together, FIG. 8 shows a continuous strip of tape 800 without such gaps between RFID tags. A straight cut or tear along any location on the tape 800 should disable at least one RFID tag. If, for example, the continuous strip of tape wraps around four sides of a box, once or multiple times, the tape cannot be severed or peeled without cutting or tearing the tape and disabling one of the RFID tags on the tape. Using a continuous strip of tape will therefore make circumventing the detection of the opening of a container more difficult.

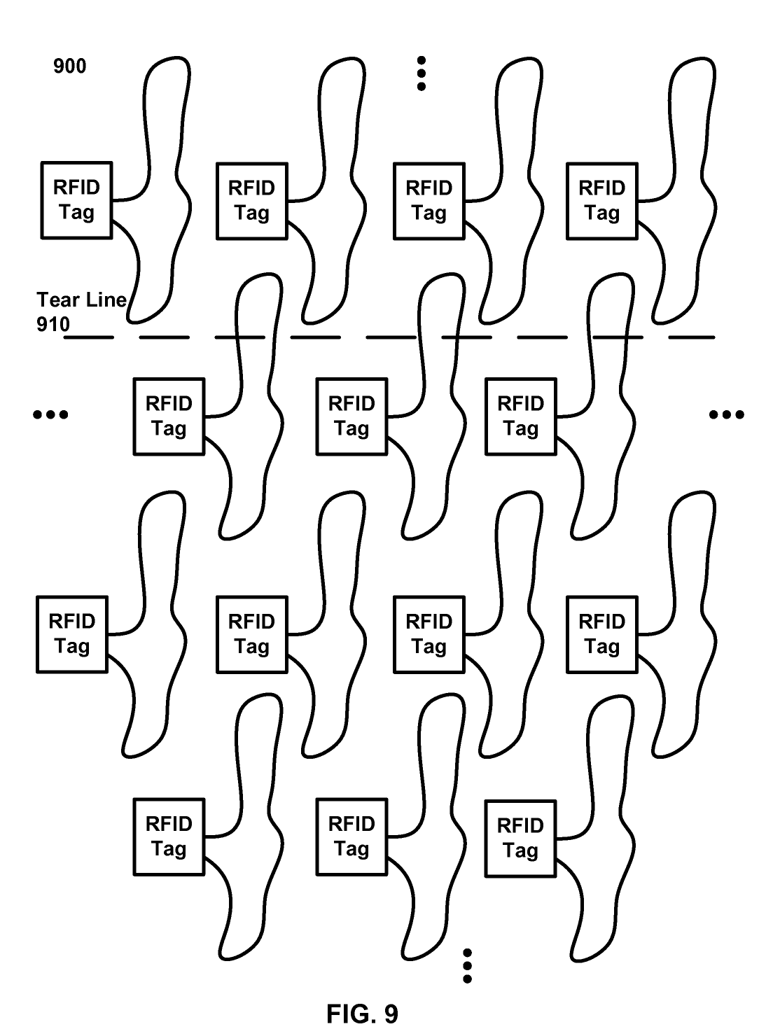

Using a wrapping material that substantially covers the surface of a container may make circumvention even more difficult. FIG. 9 shows a sheet of wrapping material 900 having RFID tags extending in two dimensions. The sheet may comprise, for example, polyester, polyolefin, PVC, other plastics, polymers, textiles, canvas, or even paper. Perforating the container would likely require cutting or tearing the sheet. Although FIG. 9 shows a tear line 910, the RFID tags are overlapped such that a sufficiently long tear or cut anywhere in the sheet in any direction should disable at least one RFID tag. The RFID tags may be arranged in a regular pattern or may be arranged in an irregular manner. The conductors extending from the main body of the RFID tags may be enlarged in order to use fewer RFID tags to cover the same area.

The shape of the conductors that extend from the main body of a RFID tag may vary among RFID tags. Some RFID tags may have closed-loop conductors that form a spiral shape, like the conductors 411 shown in FIG. 4. Some RFID conductors may have an “L” shape, like the conductors 511 in FIG. 5, and some may have a “T” shape, like in FIG. 8. Although the figures show such conductors to be two-dimensional, the conductors may also extend in a third dimension. For example, a piece of tape may have sufficient thickness to embed a three-dimensional conductor within the tape. In another example, the tape may comprise multiple layers of conductive material that sandwich insulating layers. By connecting the layers of conductive material with an electrically conducting path, the layers of conductive material may form a three-dimensional conductor.

In addition to tearing or cutting, peeling may also form a way to disable a RFID tag. FIG. 10 shows a piece of tape 1010 used to adhere an RFID tag to a container. The adhesive on the bottom (i.e. the side facing the container) of the tape may stick to two of the RFID components, 1030 and 1040. When the tape is peeled, these two components are likely to be lifted up with the tape. Another piece of tape 1050 keeps the connecting circuitry 1060 on the container. The connecting circuitry 1060 connects components 1030 and 1040 and allows the RFID tag to properly operate. To help keep the tape 1050 and connecting circuitry 1060 underneath it on the container, tape 1010 has a non-adhesive region 1020 over tape 1050. The non-adhesive region 1020 helps to prevent tape 1010 from sticking to tape 1050 so that when tape 1010 is peeled, the peeling is less likely to pull tape 1050 from the container.

After the container has been received, it may be opened by peeling the tape 1010. Because the adhesive on the tape sticks to the RFID components 1030 and 1040, peeling the tape may lift those components off of container surface. However, because there is no adhesive in region 1020 and because a separate piece of tape 1050 keeps the connecting circuitry 1060 on the container, the connecting circuitry 1060 is likely to remain on the container. The peeling action may therefore remove some RFID components from the container while leaving other components on the container. The differing forces on the different components may then sever the connecting circuitry 1060 from components 1030 and 1040. Severing the two components from the connecting circuitry may disable the RFID tag that comprises the components. The non-adhesive region 1020 is optional. That is, so long as the separate piece of tape 1050 adheres to the container tightly enough so that peeling tape 1010 will not peel tape 1050 along with it, the separate piece of tape 1050 will continue to keep the connecting circuitry 1060 adhered to the container surface.

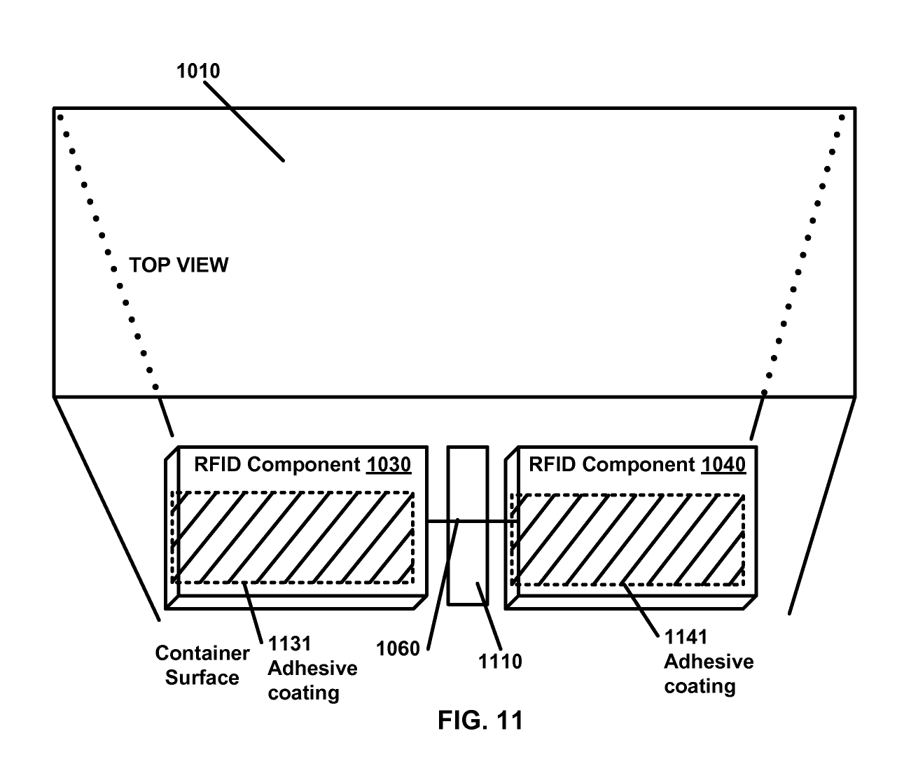

FIG. 11 shows another embodiment in which an RFID tag may be disabled by peeling the piece of tape 1010 on top of the tag. In this arrangement, the two RFID components 1030 and 1040 from FIG. 10 remain on the container, while the connecting circuitry 1060 is peeled off of the container. The two RFID components 1030 and 1040 remain adhered to the container through adhesive 1131 and 1141 coated on their bottom sides. The connecting circuitry 1060 should not be adhered to the container surface. When tape 1010 is covering the RFID tag, it should stick to the RFID components 1030 and 1040 and the connecting circuitry 1060. While the adhesives 1131 and 1141 on the bottom of components 1030 and 1040 keep them on the container, no adhesives keep the connecting circuitry 1060 on the container. Therefore, when the tape 1010 is peeled, the tape 1010 should pull the connecting circuitry 1060 away from the container and from the two components 1030 and 1040. To achieve a stronger pull on the connecting circuitry 1060, an optional supporting sheet 1110 may be placed under the connecting circuitry 1060. The supporting sheet 1110 may have an adhesive on its top side, but should not have any adhesive material on its bottom side. When the tape 1010 is peeled, it pulls on the supporting sheet 1110 as well as on the connecting circuitry 1060. This supporting sheet 1110 provides a broad surface area by which the tape 1010 may stick to and pull on. The pulling force on the supporting sheet 1110 may indirectly pull on the connecting circuitry 1060. When the connecting circuitry 1060 is pulled away from the container, it will likely sever from the RFID components 1030 and 1040. The RFID tag may be disabled by this severance.

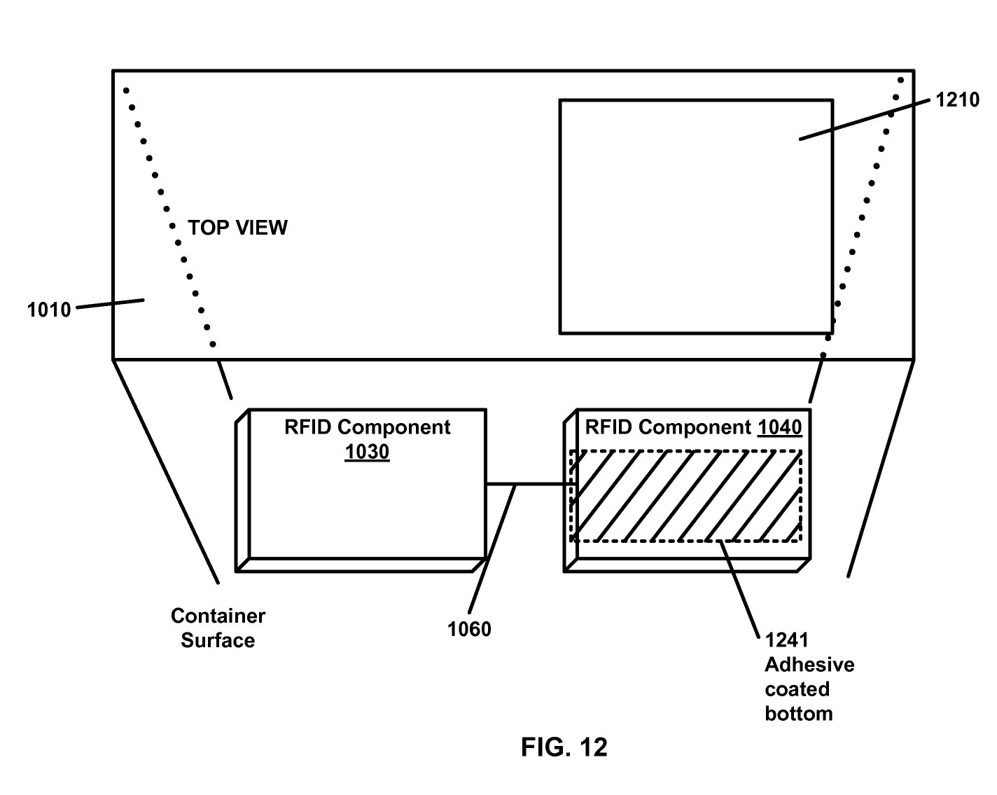

FIG. 12 shows another embodiment in which a RFID tag is disabled when the tape 1010 on top of the tag is peeled. In this arrangement, only one of the RFID components 1040 is adhered to the container through adhesive 1241 on its bottom side. An optional non-adhesive region 1210 may be placed in the portion of the tape 1010 that lies over component 1040. This non-adhesive region better ensures that the component 1040 is not pulled from the container when the tape 1010 is peeled. Because the peeling should pull component 1030 away from the container, component 1030 is likely to be severed from component 1040. This severance may disable the RFID tag.

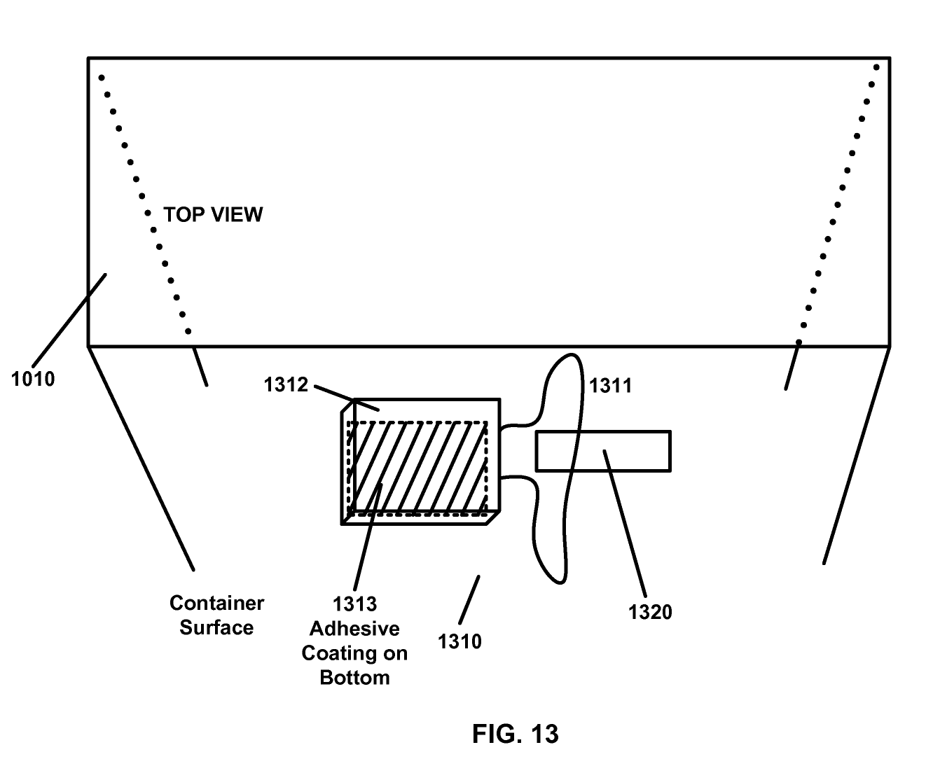

FIG. 13 shows another example in which a RFID tag 1310 may be disabled when the tape 1010 on top of the tag 1310 is disabled. One of the tag components is a conductor 1311 that extends from the main body 1312 of the tag. The main body 1312 may contain circuitry to process the signals received from the RFID antenna and accesses and processes information stored on the tag for the antenna to transmit. The conductor 1311 may form part of the antenna. Alternatively, the antenna may be separate from the conductor 1311, which may form a part of some other portion of the RFD tag 1310. The bottom side of the main body 1312 may be coated with an adhesive 1313, so that when the tape 1010 is peeled, the main body 1312 likely remains on the container. The conductor 1311 may be pulled away from the container when the tape 1010 is peeled. A supporting sheet 1320 may be placed under the conductor 1311 to better pull the conductor 1311 away from the container. Pulling the conductor 1311 away from the container may sever a portion of the conductor 1311 from the main body 1312. The severance may disable the RFID tag 1310.

The above examples show RFID components that adhere to the bottom side of a piece of tape 1010. In another embodiment, one component of a RFID tag may be embedded within the tape. Another component may continue to be on the bottom side of the tape. Adhesives may be coated on the bottom surface of the latter RFID component. When the tape is peeled from a container, the embedded component is more likely to be peeled off with the tape, while the component that was on the bottom side of the tape is more likely to remain adhered to the container. The differing forces on these two components will likely sever them and disable the tag.

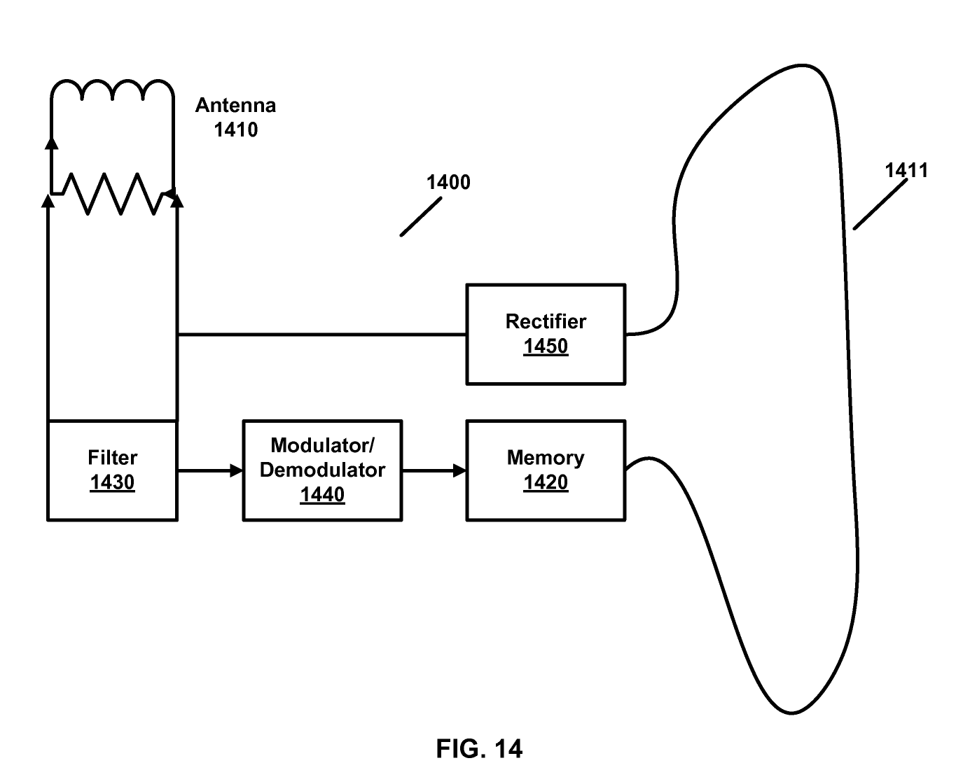

FIG. 14 shows one version of a passive RFID tag 1400 that may be used in detecting whether a container has been opened. In general, a RFID tag may have an antenna 1410 for transmitting and receiving wireless signals. The antenna may be a general piece of conducting wire, or a two-dimensional conducting sheet. FIG. 14 shows the antenna 1410 and a conductor 1411 as two separate components. In that case, disabling a conductor that extends from the main body of a RFID tag does not require disabling the antenna of the tag. Other embodiments may use a conductor like 1411 as the RFID antenna. In that case, disabling a conductor that extends from the main body of a RFID tag may be accomplished by disabling the tag's antenna.

The power to operate the passive tag 1400 of FIG. 14, including the power to access the memory 1420 and transmit signals may come primarily from the energy gathered by the antenna 1410. For example, the wireless signal that requests identification information from a RFID tag may be broadcasted with enough power so that the power reaching the tag's antenna 1410 may be collected in sufficient quantities to operate the tag. The current from the antenna 1410 may be rectified to provide DC power to the memory 1420. The power may be carried from the rectifier 1450 to the memory 1420 through the conductor 1411. Severing the conductor 1411 may deprive the RFID circuitry of power and disable the tag 1400. This RFID tag 1400 may be arranged so that tearing a tape on which the tag 1400 is placed likely severs the conductor 1411.

Operating the tag may also require powering the filter 1430 and modulator/demodulator 1440, but these may also be passive components. The collected power may also be stored for future operations.

The RFID tag and RFID scanner may operate in the range of kHz to hundreds of GHz. However, they may also operate in lower or higher frequency ranges. The filter 1430 of FIG. 14 may isolate the frequency range in which the RFID tag is intended to operate. The filtered signal may then be demodulated. If the demodulated signal indicates a command to access memory 1420, then the RFID tag's memory 1420 is also accessed using the power collected by the antenna 1410. A microprocessor (not shown) may be used to access the memory 1420 and perform other tasks. The accessed information may then be modulated and transmitted by the antenna 1410.

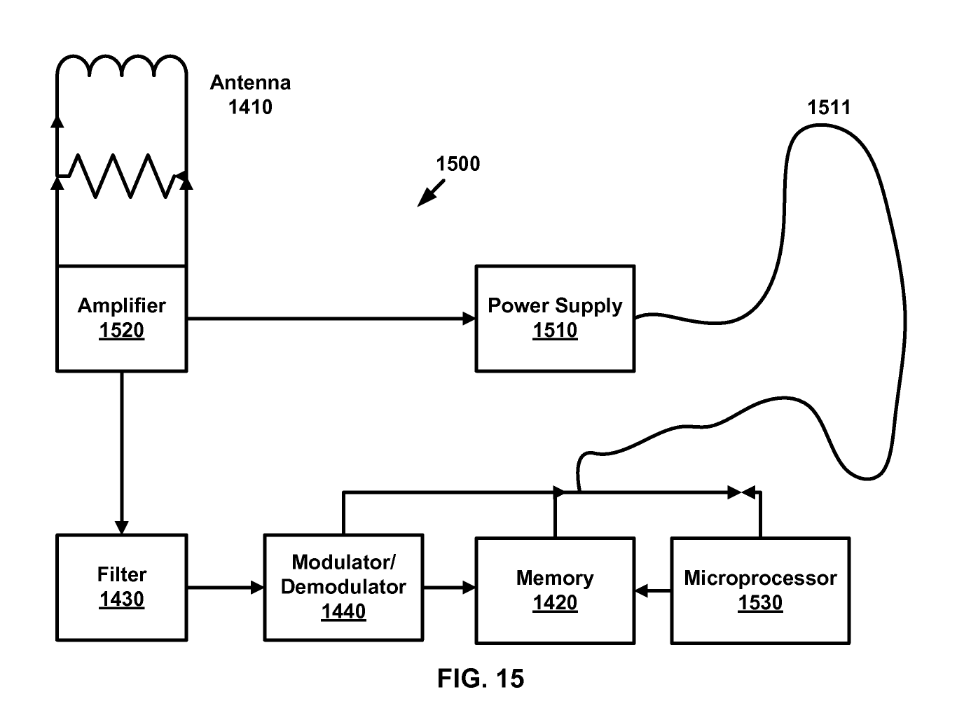

FIG. 15 shows an active RFID tag 1500 that incorporates a power source 1510. The power is provided to the RFID circuitry through conductor 1511. Severing this conductor 1511 may deprive the circuitry of power and disable the tag 1500. The RFID tag 1500 may be arranged so that tearing a tape on which the tag 1500 is placed likely severs the conductor 1511.

The power supply 1510 may allow for inclusion of other power-consuming components, such as an amplifier 1520 and microprocessor 1530. The tag may also better afford using active components for the filter 1430 and modulator/demodulator 1440.

The RFID tags may be fabricated on a rigid material, such as a circuit board. They may also be fabricated on flexible materials. In the latter case, the tag components may be printed on the material. The printing may be done using, for example, organic or silicon ink.

In view of the many possible embodiments to which the principles of this disclosure may be applied, it should be recognized that the illustrated embodiments are only preferred examples and should not be taken as limiting the scope of the invention.

In this specification, “a” and “an” and similar phrases are to be interpreted as “at least one” and “one or more.”

While various embodiments have been described above, it should be understood that they have been presented by way of example, and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) embedded RF ID tags in tape. However, one skilled in the art will recognize that embodiments of the invention could involve embedding the RF ID tags in other materials other than tape to detect tapering. For example, one could embed the RF ID tags directly in box materials to detect if the box has been cut into directly.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method of tracking whether a container has been opened, comprising:
attaching a first RFID device to an area of the container that is capable of having an opening made or expanded in the area, such that when the container is opened at the area, the first RFID device is disabled.

2. The method of claim 1 for tracking whether a container has been opened, wherein the attaching of the first RFID device comprises attaching an RFID device having a closed-loop conductor that extends from the main body of the RFID device, such that when an opening is made or expanded at the area, the RFID device is disabled.

3. The method of claim 2 for tracking whether a container has been opened, further comprising using the closed-loop conductor to transmit or receive wireless signals.

4. The method of claim 1 for tracking whether a container has been opened, wherein the attaching of the first RFID device comprises placing the first RFID device to intersect an edge of a closing portion of the container, the portion capable of moving relative to the body of the container to enclose or expose the inside of the container.

5. The method of claim 1 for tracking whether a container has been opened, wherein the attaching of the first RFID device comprises substantially enclosing the container with a sheet having the first RFID device on or within the sheet.

6. The method of claim 1 for tracking whether a container has been opened, wherein the attaching of the first RFID device comprises placing on the container a sheet coated with adhesive material, the sheet having the first RFID device on or within the sheet.

7. The method of claim 1 for tracking whether a container has been opened, further comprising storing identification information of the first RFID device in a database.

8. The method of claim 1 for tracking whether a container has been opened, further comprising attaching a second RFID device to the container.

9. The method of claim 8 for tracking whether a container has been opened, wherein the attaching of the second RFID device comprises placing the second RFID device at a position on the container at which the second RFID device will not be disabled when the container is opened.

10. The method of claim 9 for tracking whether a container has been opened, wherein the attaching of the second RFID device further comprises placing the second RFID device to not intersect any edge of a closing portion of the container, wherein the portion is capable of moving relative to the body of the container to enclose or expose the inside of the container.

11. The method of claim 8 for tracking whether a container has been opened, further comprising:
a. monitoring for the transmission of identification information from the first RFID device or the second RFID device;
b. associating in a database any identification information received from the first RFID device with the container; and
c. associating in the database any identification information received from the second RFID device with the container.

12. The method of claim 8 for tracking whether a container has been opened, wherein the attaching of the first RFID device and of the second RFID device comprises placing a closed-loop conductor that extends from the main body of the first RFID device and a closed-loop conductor that extends from the main body of the second RFID device such that all straight lines that are between the first RFID device and second RFID device and are not intersecting the main body of the first RFID device or second RFID device intersect the closed-loop conductor of the first RFID device and/or the second RFID device.

13. The method of claim 12 for tracking whether a container has been opened, wherein the attaching of the first RFID device and of the second RFID device further comprises substantially enclosing the container with a sheet having the first RFID device and the second RFID device on or within the sheet.

14. A wrapping material, comprising
a. a sheet of non-rigid material;
b. a first substantially planar RFID device that is attached to the sheet of non-rigid material, the first RFID device having a main body and a closed-loop conductor extending from the main body of the first RFID device; and
c. a second substantially planar RFID device that is attached to the sheet of non-rigid material, the second RFID device having a main body and a closed-loop conductor extending from the main body of the second RFID device; and
wherein the closed-loop conductor of the first RFID device is arranged relative to the closed-loop conductor of the second RFID device such that all straight lines that lie between the first RFID device and the second RFID device and that do not intersect the main body of the first RFID device or the second RFID device intersect the closed-loop conductor of at least one of the first RFID device and the second RFID device.

15. The wrapping material of claim 0, wherein the sheet of non-rigid material has a substantially rectangular shape and wherein the first substantially planar RFID device and the second substantially planar RFID device are arranged longitudinally along the length of the sheet of non-rigid material.

16. The wrapping material of claim 15, wherein the sheet has a first line of perforations that runs parallel to the width of the sheet and intersects the closed-loop conductor that extends from the main body of at least one the first RFID device and the second RFID device.

17. The wrapping material of claim 16, wherein the sheet has a second line of perforations that runs parallel to the width of the sheet and that runs on the same side of both the first RFID device and of the second RFID device.

18. The wrapping material of claim 0, further comprising a third substantially planar RFID device that is attached to the sheet of non-rigid material, the third RFID device having a main body and a closed-loop conductor extending from the main body of the third RFID device; and wherein the closed-loop conductor of the second RFID device is arranged relative to the closed-loop conductor of the third RFID device such that all straight lines between the second RFID device and third RFID device not intersecting the main body of the second RFID device or the third RFID device intersect the closed-loop conductor of at least one of the second RFID device and the third RFID device.

19. A system for tracking whether a container has been opened, comprising a first RFID device configured to be attached to a container and to be disabled when an opening into the container is made or expanded.
The system of claim 19 for tracking whether a container has been opened, further comprising a second RFID device configured to be attached to a container.

20. The system of claim 0 for tracking whether a container has been opened, further comprising a detector configured to monitor whether identification information is received from the first RFID device; and wherein the first RFID device has a receiver configured to receive energy from wireless signals.

21. The system of claim 20 for tracking whether a container has been opened, further comprising a database that associates identification information of the first RFID device to the container.
